(19) United States
(12) Patent Application Publication
(10) Pub. No.: US 2010/0105806 A1
(43) Pub. Date: Apr. 29, 2010

(54) PASSIVE ELECTRICAL ARTICLE

(75) Inventors: Rui Yang, Austin, TX (US); John R. Gardner, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/603,357

(22) Filed: Oct. 21, 2009

Related U.S. Application Data
(60) Provisional application No. 61/108,367, filed on Oct. 24, 2008.

(51) Int. Cl. C08K 3/10

(52) U.S. Cl. 523/201; 524/413

(57) ABSTRACT

An electrical article including a dielectric layer having a resin, dielectric particles, a dispersant, and core shell rubber particles.

### CROSS-REFERENCE TO RELATED APPLICATIONS

The present application claims priority to U.S. Provisional Patent Application 61/108,367, filed Oct. 24, 2008.

### TECHNICAL FIELD

This invention relates to passive electrical articles. In particular it relates to the dielectric layer in passive electrical articles such as capacitors and resistors.

### BACKGROUND

Electrical articles such as the capacitors and resistors described in U.S. Pat. No. 6,274,224 and U.S. Pat. No. 6,577,492 typically include a polymeric insulating or electrically conducting layer between first and second self supporting substrates.

The dielectric material of the insulating layer is typically a metal oxide, such as tantalum oxide, or a high dielectric constant ceramic, such as barium titanate. The dielectric material can be dispersed in a matrix of some thermally and mechanically stable polymer, such as an epoxy. The electrical articles can be used as a layer in printed wiring boards and multichip modules.

### SUMMARY

One embodiment of the present invention features an electrical article comprising: a dielectric layer comprising a resin, dielectric particles, and core shell rubber particles.

Another embodiment of the present invention features a method of making a dielectric layer precursor comprising: creating a first dispersion comprising dielectric particles, creating a second dispersion comprising core shell rubber particles and epoxy, and mixing the first and second dispersions.

An advantage of at least one embodiment of the present invention is that it provides a flexible high dielectric constant composite material suitable for use in an embedded capacitor. Compared to prior art products, it provides improved flexibility, adhesion, and peel strength without sacrificing capacitance or other electric properties.

Another advantage of at least one embodiment of the present invention is that it allows double-sided copper patterning of a capacitor laminate, which enables a process cost reduction.

Other features and advantages of the invention will be apparent from the following drawings, detailed description, and claims.

### DETAILED DESCRIPTION

In one aspect, the invention is a dielectric layer that may be used in an electrical article, such as a capacitor or resistor. The electrical articles generally include a first self-supporting substrate having two opposing major surfaces and a second self-supporting substrate having two opposing major surfaces. A dielectric layer between the first and second substrate provides an electrical insulating function and adheres the two substrates.

The dielectric layer of the electrical article, which may be made of one or more layers, is made of a polymer. Any polymer may be used that can withstand the temperatures encountered in a typical solder reflow operation, for example, about 180 to about 290° C. Suitable polymeric materials for the dielectric layer include acrylates, allyated polyphenylene ether, benzocyclobutene, bismaleimide triazine, cyanate ester, polyimide, polyamide, polyester, polyphenylene oxide, and polytetrafluoroethylene, epoxy resins and blends thereof, and combinations of the foregoing.

Suitable epoxy resin compositions may be made from thermally curable epoxy resins. The term epoxy resin composition will typically be used to refer to an uncured composition. An exemplary epoxy resin composition includes one or more aromatic polyepoxides and one or more 9,9-bis(aminophenyl)fluorene curing agents. Suitable aromatic polyepoxides include poly(glycidyl ether)s of polyhydric phenols and epoxy resins available from Hexion Specialty Chemicals Company, Houston, Tex., under the trade designation EPON 1001F and EPON 1050. Other suitable epoxy resins include blends of a diglycidylether of bisphenol A and a novolac epoxy, for example, 75 to 90% by weight EPON 1001F and 25 to 10% by weight EPON 1050F based on the total weight of the resin. A suitable 9,9-bis(aminophenyl)fluorene curing agent for use in the epoxy resin compositions of the invention is described in U.S. Pat. No. 4,684,678.

Some planar capacitive materials include a dielectric particle-loaded epoxy layer between two copper sheets. To achieve a high dielectric constant dielectric material, the loading levels of the dielectric particles may be very high, which makes the dielectric material very brittle. Because it is so brittle, it cannot endure being processed as a free-standing layer. For example, if both copper sheets are to be pattern etched, the brittleness of the dielectric layer requires that one copper sheet is etched, a supporting layer is applied to the etched copper layer, then the other copper layer is etched. In this manner, the dielectric layer is always supported on at least one side.

The present invention provides a more flexible and robust dielectric layer, which allows both copper sheets to be etched at the same time. This enables a faster and more efficient manufacturing process. The present invention provides these benefits while also providing a dielectric constant and capacitance on par with existing dielectric materials. The improved properties of the dielectric material of the present invention are achieved by using a core shell rubber (CSR) toughening material in the dielectric layer. A suitable CSR has a core comprising a copolymer formed from butadiene/styrene, polybutadiene, and siloxane and a shell comprising a copolymer compatible with thermosetting resin and is available in a dispersion comprising MEK and epoxy under the trade designation KANE ACE MX from Kaneka Tex. Corporation, Pasadena, Tex. Materials suitable for forming the rubber core include natural rubbers such as polyisoprene and synthetic rubbers such as styrene-butadiene rubber (SBR), SBS block copolymer, polybutadiene, and siloxane. The CSR particles are generally spherical. A suitable diameter depends on the application for which it will be used, but typical ranges include about 50 to about 150 nm, more typically 100 nm. Preferably the particles used in a particular application have an average particle diameter with a narrow (i.e., substantially uniform) particle size distribution. The CSR is mixed uniformly into an epoxy resin by Kaneka. The loading of CSR particles into the CSR dispersion can be up to about 50 wt %, preferably 30%, based on the total weight of the epoxy resin.

A dielectric particle dispersion is also formed. Suitable particles include barium titanate, barium strontium titanate, titanium oxide, lead zirconium titanate, calcium copper titanate, lead magnesium titanate, lead lanthanium zirconate titanate, silicon dioxide, and mixtures thereof. The particles may be any shape and may be regularly or irregularly shaped. Exemplary shapes include spheres, platelets, cubes, needles, oblate, spheroids, pyramids, prisms, flakes, rods, plates, fibers, chips, whiskers, and mixtures thereof. A suitable particle size, e.g., diameter, may have a lower range of about 100 nm to about 0.05 nm and an upper range of about 2 micrometer (μm) to about 11 μm. Typically, the particles have a size allowing at least two to three particles to be stacked vertically within the electrically insulating layer thickness. The inventors have found that dielectric layers with spherical dielectric particles having a small diameter, e.g., about 100 nm, had better strength and flexibility than dielectric layers with spherical particles having an average diameter of about 0.5 μm and a distribution range of about 0.3 to about 0.9 μm.

Adding the dielectric particles increases the dielectric constant of the resulting dielectric layer. The higher the loading, the higher the dielectric constant. However, the resulting dielectric material often becomes brittle at high loading percentages, e.g., above 60 or 70 wt %. The present invention allows for optimum performance of the dielectric material at higher particle loading percentages, e.g., in the range of about 60 to about 90 wt %, particularly about 74 to about 88 wt %.

When the large amount of particles is added to the polymer, e.g., an epoxy, the mixture becomes gelatinous or almost solid. Due to this factor, it was not known, prior to this invention, if the CSR material could be successfully added and dispersed into the mixture. It was anticipated that the CSR material would agglomerate and not disperse evenly throughout the material. However, the inventors were able to successfully achieve a dispersed mixture by separately mixing the CSR material with a dispersing agent and epoxy then adding this mixture to a dielectric particle/dispersant mixture. A suitable dielectric layer formed from the dispersed mixtures of the present invention may include about 70 to about 90 wt % dielectric particles, about 1 to about 15 wt % CSR particles, and about 10 to about 20 wt % polymer, e.g., epoxy. A particularly suitable dielectric layer formed from the dispersed mixtures of the present invention may include about 74 to about 88 wt % dielectric particles, about 3 to about 12 wt % CRS particles, and about 9 to about 17 wt % epoxy.

Particularly suitable dispersants are polypropylene oxide-based dispersants having high molecular weights available under the trade designations SOLSPERSE 76500 and SOLSPERSE 71000 from Lubrizol, Ltd., United Kingdom. SOLSPERSE 76500 is a 50% active polymeric dispersant in n-butyl acetate containing quaternary amine and polypropylene oxide and is typically used to improve pigment dispersion and stability in liquid organic media. SOLSPERSE 71000 is a 100% active polymeric dispersant containing polyethyleneimine, polypropylene oxide, and polyethylene oxide copolymer and is typically used to improve pigment dispersion and stability in UV-cured coatings. Another suitable dispersant is a polyester-polyamine based polymer available under the trade designation SOLSPERSE 24000 from Lubrizol, Ltd., United Kingdom.

Dispersions suitable for use in the present invention may also include conventional solvents. Examples of suitable solvents include methyl ethyl ketone and methyl isobutyl ketone. Other additives, such as agents to change viscosity or to produce a level coating, can be used.

A coatable resin composition of the present invention is typically formed from a mixture of resin, a dispersant, a curing agent, the dielectric and CSR particles, and other optional ingredients. The resulting substantially uniform mixture is subsequently coated on a suitable substrate, then heated for a time and a temperature sufficient to remove volatile components and cure the composition. The resulting cured resin composition forms the dielectric layer of the electrical article.

The substrates of the electrical article of the invention may include a single layer, or a plurality of layers arranged in a laminate structure. The first and second substrates may be made of graphite; composites such as silver particles in a polymer matrix; metal such as copper or aluminum; combinations thereof, or laminates thereof. A multilayer substrate may be made by coating a layer of metal, such as copper or aluminum, onto a removable carrier layer. For example, copper layer may be coated onto a removable polyester carrier. The first and second substrates may be the same or different. The electrical article of the invention may include multiple insulating and conductive layers.

A substrate in accordance with the electrical articles of the invention is preferably self-supporting. The term “self-supporting substrate” refers to a substrate having sufficient structural integrity such that the substrate is capable of being coated and handled. It is preferable that a substrate is flexible; however, rigid substrates may also be used.

Typically, the major surface of the first substrate in contact with the dielectric layer and the major surface of the second substrate in contact with the dielectric layer are electrically conductive when forming a capacitor. Surface treatment, which adds material to these major surfaces by, for example, oxidation or reaction with a coupling agent, may be used to promote adhesion. Alternatively, a separate coating step may be performed to apply an adhesion promoting primer, such as 5-aminobenzotriazole. Treatment of the substrate surface with 5-aminobenzotriazole may be particularly relevant for copper foils not having a chromate anti-tarnish surface treatment. The resulting material on the major surface of the substrate itself may not necessarily be conductive, but a capacitor is formed provided the substrates themselves are conductive.

Typically, a substrate has a thickness ranging from 0.35 to 3 mils (approximately 9 to 80 μm), more typically 0.35 to 1.5 mils (approximately 9 to 38 μm).

A preferred substrate is copper. Exemplary copper includes copper foil available from Carl Schlenk, AG, Nurnberg, Germany.

A method for manufacturing an electrical article of the invention includes providing a first substrate having two opposing major surfaces. A resin composition may then be coated onto a first major surface of the first substrate. A second substrate, having two opposing major surfaces, is laminated to the resin composition on the first major surface of the first substrate. The resulting laminate is then heated for a time and a temperature sufficient to cure the epoxy resin composition.

Alternatively, the second substrate may also include a resin composition on its first major surface and the first and second substrates may be laminated together to connect the first major surface of each of the first and second substrate, i.e., the resin coated side of each substrate may be laminated together.

The major surfaces of the substrates are preferably substantially free of debris or chemisorbed or adsorbed materials to maximize adhesion with the electrically insulating layer. Suitable substrate cleaning methods known in the art may be used.

The cleaned substrate may be coated with the resin composition using any suitable method, for example, a gravure coater. The resin composition is then dried to remove residual solvent. The dry thickness of the coated resin composition depends on the percent solids in the composition, the relative speeds of the gravure roll and the coating substrate, and on the cell volume of the gravure used. Typically, to achieve a dry thickness in the range of about 3 to about 10 μm, the percent solids in the resin composition are about 20 to 75% by weight. The coating is typically dried to a substantially tack-free state in the oven of the coater, typically at a temperature of less than about 100° C. More typically, the coating is dried in stages starting with a temperature of about 30° C. and ending with a temperature of about 100° C., and then wound onto a roll. Higher final drying temperatures, e.g., up to about 200° C. can be used, but are not required.

It is preferable, before laminating two substrates coated with a dielectric layer, that at least one of the dielectric layers is partially cured. Lamination is preferably carried out using two of the coated substrates described above. One or both of the coated substrates may go through an oven or over a heated roller before reaching the laminator, for example, at a temperature ranging from about 125 to about 200° C. for less than 30 seconds, and more typically at a temperature about 125 to about 175°.

To make an electrical article of the present invention, the coated substrates may be laminated, dielectric layer to dielectric layer, using a laminator with two nip rollers heated to a temperature ranging from about 120 to about 200° C., typically about 135° C. Suitable air pressure is supplied to the laminator rolls, typically at a pressure ranging from about 5 to about 40 psi (34 to 280 kPa), typically about 15 psi (100 kPa). The roller speed can be set at any suitable value and typically ranges from about 12 to about 36 inches/minute (0.5 to 1.5 cm/second), more typically about 15 inches/minute (0.64 cm/second). This process can be conducted in a batch mode as well.

In an alternate embodiment a reinforcing material such as a woven or non-woven material may be laminated between the dielectric layers. Examples of suitable reinforcing materials include nonwoven materials formed into a web such as liquid crystal polymer (LCP), nylon, polyester, polystyrene, polyacrylonitrile, polypropylene, and combinations thereof. The nonwoven webs may be of any suitable form such as, but not limited to, meltblown nonwovens, spunbond nonwovens, and electrospun nonwovens. Examples of suitable woven materials are described, e.g., in WO9402310

The laminated material can be cut into sheets of the desired length or wound onto a suitable core.

The laminated material is then heated for a sufficient time and temperature to cure the resin composition. Exemplary curing temperatures include temperatures ranging from about 150 to about 225° C., typically about 160 to about 200° C., and exemplary curing times include a period ranging from about 90 to about 180 minutes, typically about 90 to about 120 minutes.

Although an electrical article of the present invention can be functional as it is fabricated, the electrical article may be patterned, for example, to form discrete islands or removed regions in order to limit lateral conductivity. The patterned electrical article may be used as a circuit article itself or as a component in a circuit article.

A surface of the first or second substrate of the electrical article that is accessible may be contacted, for example, by an electrical trace, to make electrical contact so that the first or second substrate acts as an electrode. In addition, it may be desirable to make electrical contact with the major surface of the first or second substrate in contact with the dielectric layer or to provide a through hole contact. Through hole contacts are useful when no interaction with the electrical device is desired. In order to reach the major surface of the first or second substrate in contact with the dielectric layer or to provide a through hole contact, the electrical article may be patterned. Any suitable patterning technique known in the art may be employed.

An electrical article of the present invention may further comprise one or more additional layers, for example, to prepare a PWB or flexible circuit. The additional layer may be rigid or flexible. Exemplary rigid layers include fiberglass/epoxy composite commercially available from Polyclad, Franklin, N.H., under the trade designation PCL-FR-226, ceramic, metal, or combinations thereof. Exemplary flexible layers comprise a polymer film such as polyimide or polyester, metal foils, or combinations thereof. Polyimide is commercially available from DuPont under the trade designation KAPTON and polyester is commercially available from 3M Company, St. Paul, Minn., under the trade designation SCOTCHPAR. These additional layers may also contain electrically conductive traces on top of the layer or embedded within the layer. The term “electrically conductive traces” refers to strips or patterns of a conductive material designed to carry current. Suitable materials for an electrically conductive trace comprise copper, aluminum, tin, solder, silver paste, gold, and combinations thereof.

A circuit article may be made by providing an electrical article of the present invention, patterning at least one side of the electrical article, attaching an additional layer to the patterned side of the electrical article, and providing at least one electrical contact to at least one substrate of the electrical article. Typically, the second side of the electrical article is subsequently patterned and a second additional layer is provided and attached to this second side of the electrical article. In a preferred embodiment, a circuit article is made by providing an electrical article of the present invention, simultaneously patterning both sides of the electrical article, and subsequently attaching an additional layer to one or both sides of the electrical article.

An electrical article of the present invention can be used in a printed circuit board or printed wiring board (PWB), for example, a flexible circuit, as a component, which functions as a capacitor.

The electrical article may be embedded or integrated in the PWB or flexible circuit. Methods for manufacturing a flexible circuit or PWB using the electrical article of the present invention are described in WO 00/45624 and are incorporated herein by reference.

The present invention also encompasses an electrical device comprising an electrical article of the present invention functioning in an electrical circuit of a PWB or a flexible circuit. The electrical device may include any electrical device which typically employs a PWB or flexible circuit having a capacitive component. Exemplary electrical devices include cell phones, telephones, fax machines, computers, printers, pagers, and other devices as recognized by one skilled in the art. The electrical article of the present invention is particularly useful in electrical devices in which space is at a premium or that operate at frequencies greater than 1 GHz.

### EXAMPLES

This invention is illustrated by the following examples, but the particular materials and amounts thereof recited in these examples, as well as other conditions and details should not be construed to unduly limit this invention.

### Materials

Barium titanate (BaTiO3): Nippon Chemical Industrial Co., Ltd., Tokyo, Japan
Chloraniline Fluorenone (CAF) Amine Curative R-55365 Intermediate, CAS #107934-68-9: 3M Company, St. Paul, Minn.
Solvents: Methylethylketone (MEK), Methylisobutylketone (MIBK)
Dispersants: SOLSPERSE 24000, SOLSPERSE 71000, and SOLSPERSE 76500: Lubrizol, Ltd., United Kingdom
Epoxy: EPON 1001F: Hexion Specialty Chemicals Company, Houston, Tex.
Core Shell Rubber (CSR): two-layer sphere available in KANE ACE MX 181 CSR dispersion; inner layer is a co-polymer formed from butadiene/styrene, polybutadiene, and siloxane; outer core is a co-polymer compatible with thermosetting resins.
CSR dispersion: KANE ACE MX 181 (23.5 wt % MEK, 19.5 wt % CSR, and 57 wt % EPON 1001F)

### Equipment

Mixing: Dispermat laboratory dissolvers from BYK-Gardner (Columbia, Md.)
Milling: MiniCer lab mill, LMZ-2 mill from Netzsch Fine Particle Technology (Exton, Pa.)
Particle Size Distribution Analyzer: Partica LA-950 from Horiba Instruments, Inc (Irvine, Calif.)
Peel Tester: Instron model 5567 from Instron Corporation (Canton, Mass.)

### Test Methods

Peel Strength Test: IPC TM-650-2.4.8: Peel Strength of Metallic Clad Laminates

### Example

Step 1: Mix 4100 grams (g) BaTiO₃ with 50 g SOLSPERSE 76500 dispersant and 900 gm MEK using Dispermat Dissolver.
Step 2: Mill the mixed solution of step 1 in the MiniCer (or LMZ-2) to produce a milled dispersion.
Step 3: Mix 1500 g KANE ACE MX 181 with 213 g CAF and 5500 g MEK using Dispermat Dissolver.
Step 4: Mix the solutions from steps 2 and 3 together to produce a final solution of 48% solids, which yields 75 wt % BaTi and 5.3 wt % CSR.
Step 5: Coat the final dispersion onto two pieces of copper foil and air dry the dispersion to produce a dry dielectric thickness of about 8 micrometers.
Step 6: Laminate the two coated copper pieces together using a standard nip roller laminator.
Step 7: Conduct a final high temperature cure in air at 190° C. for 4 hours.

The capacitance of the capacitor laminates were measured using a standard ohmmeter and the thickness of the dielectric layer was measured. The capacitive density was calculated by dividing the measured capacitance (C) by the area (A) of the sample.

Table 1 shows the measured peel strengths for the capacitor laminate samples. The measurement was taken for each finished sample to determine the Initial Peel Strength. The samples were then placed in an oven set at 220° C. for 4 hours and 288° C. for 90 seconds.

TABLE 1

| | Initial | Heated Peel | Heated Peel | | |
|---|---|---|---|---|---|
| | Peel | Strength | Strength | | |
| Ex- | Strength | 220° C./4 hrs | 288° C./90 sec | Thickness | C/A |
| ample | (lb/in) | (lb/in) | (lb/in) | (μm) | (nF/in2) |
| 1 | 8.00 | 5.35 | 7.19 | 16.00 | 5.60 |
| 2 | 7.70 | 5.98 | 7.73 | 17.00 | 5.50 |
| 3 | 7.21 | 6.00 | 7.55 | 18.00 | 5.50 |

Various modifications and alterations of this invention will become apparent to those skilled in the art without departing from the scope and spirit of this invention and it should be understood that this invention is not to be unduly limited to the illustrative embodiments set forth herein.

What is claimed is:

1. An electrical article comprising:
a dielectric layer comprising the reaction product of a resin, dielectric particles, and core shell rubber particles.

2. The electrical article of claim 1 wherein the resin is selected from the group consisting of epoxy, acrylates, allyated polyphenylene ether, benzocyclobutene, bismaleimide triazine, cyanate ester, polyimide, polyamide, polyester, polyphenylene oxide, polytetrafluoroethylene and combinations thereof.

3. The electrical article of claim 1 wherein the dielectric particles are selected from the group consisting of barium titanate, barium strontium titanate, titanium oxide, lead zirconium titanate, calcium copper titanate, lead lanthanium zirconate titanate, lead magnesium titanate, silicon dioxide, and mixtures thereof.

4. The electrical article of claim 1 wherein the dielectric particles are barium titanate.

5. The electrical article of claim 1 wherein the dielectric particles comprise about 60 to about 90 wt % of the dielectric layer.

6. The electrical article of claim 1 wherein the dielectric particles have an average diameter of about 100 nm.

7. The electrical article of claim 1 wherein the core shell rubber particles comprise about 3 to about 12 wt % of the dielectric layer.

8. The electrical article of claim 1 wherein the core shell rubber particles have an average diameter of about 100 nm.

9. The electrical article of claim 1 wherein the core shell rubber particles have a core comprising a polybutadiene co-polymer and a shell comprising a co-polymer compatible with a thermosetting resin.

10. The electrical article of claim 1 further comprising a dispersant.

11. The electrical article of claim 10 wherein the dispersant comprises one or both of a polypropylene oxide and polyethylene oxide copolymer.

12. The electrical article of claim 10 wherein the dispersant comprises one or both of a polyethyleneimine amine and a quarternary amine.

13. The electrical article of claim 10 wherein the dispersant comprises polypropylene oxide chains and amine groups.

14. The electrical article of claim 1 wherein an embedded capacitor comprises the dielectric layer.

15. The electrical article of claim 1 wherein a printed circuit board comprises the dielectric layer.

16. A method of making a dielectric layer precursor comprising:
creating a first dispersion comprising dielectric particles,
creating a second dispersion comprising core shell rubber particles and epoxy, and
mixing the first and second dispersions.

17. The method of claim 16 wherein the first dispersion comprises up to about 90 wt % dielectric particles.

18. The method of claim 16 wherein the dielectric particles have an average diameter of about 100 nm.

19. The method of claim 16 wherein the second dispersion comprises up to about 50 wt % core shell rubber particles.

20. The electrical article of claim 16 wherein the core shell rubber particles have an average diameter of about 100 nm.
